(19) United States
(12) Patent Application Publication
(10) Pub. No.: US 2009/0051813 A1
(43) Pub. Date: Feb. 26, 2009

(54) IMAGE PROCESSING DEVICE

(75) Inventors: Tomohiro Sasao, Ehime (JP); Masaki Toyota, Ehime (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/911,753

(22) PCT Filed: Apr. 14, 2006
(86) PCT No.: PCT/JP2006/307905

§ 371 Date: Oct. 17, 2007

(30) Foreign Application Priority Data
Apr. 26, 2005 (JP) 2005-127233

(51) Int. Cl. H04N 5/45

(52) U.S. Cl. 348/565

(57) ABSTRACT

A television screen or a PC screen can be displayed on the monitor (21) of an existing PC (17) or an overlay display of the combined two screens can be carried out. Any of the displays can be easily changed at any position with any window size by an operation through the PC (17). Even if the PC (17) is stopped, a television screen can be displayed on the monitor (21) of the PC (17) and viewed by the user. The image processing device can be used as a recorder.

### TECHNICAL FIELD

The present invention relates to an image processing device in the field of visual equipments or data storages, and more particularly to use of a picture-in-picture technique.

### BACKGROUND ART

As a conventional device for realizing television reception and recording through a personal computer (hereinafter, referred to as PC), a television tuner board equipped with a television tuner function and a capture board equipped with an image capture function are connected to the PC equipped with a hard disk drive (hereinafter, referred to as HDD) and a recording type digital video disc (DVD) drive, and television reception software and image recording software are installed therein.

When the PC as described above is used, it is possible to watch a television on a monitor of the PC, record a television program on the HDD embedded in the PC, edit with an application, and copy recorded television data from the HDD to the DVD. In addition, if a PC system is equipped with a picture-in-picture function, the television can be viewed in an overlay display screen while enjoying the Internet on the monitor.

On the other hand, there is a television recorder equipped with the HDD and the recording type DVD drive also in the field of a household electrical appliance. In recent years, there have been additional functions capable of establishing an Internet connection using a network cable (such as a local area network (LAN) or the like) and making a recording reservation using a television program listing on the Internet as disclosed in Japanese Patent Unexamined Publication No. 2001-8144.

### DISCLOSURE OF THE INVENTION

### Problem to be Solved by the Invention

However, a load on a central processing unit (CPU) of the PC increases during the television reception in the device for realizing the television reception and recording through the PC as described above. When the television reception and recording are performed during another work process on the PC, there is a problem that a work operation may not be comfortably carried out due to a slow software operation, a hang-up operation in which the process is stopped in the worst case or the like. When the recording reservation is made, there is a problem that the PC needs to be activated and an abnormal operation is caused due to compatibility with another application according to operating systems, such that a normal reservation may not be made or high power may be also consumed by the PC operation during the reservation.

Since a television recorder of a household electrical appliance can not easily perform a recording or playback operation through the PC and can not output a television screen on the PC monitor, an output operation to a separate television is required. When the television and recorded program are viewed using the PC, there is a problem in that power consumption may increase since a PC monitor and a television display device are required and it is difficult to simultaneously view the two display devices.

The invention is made to address the conventional problems as described above and it is an object of the invention to provide an image processing device capable of enabling a television or recorded program to be viewed without increasing a PC load, displaying a small screen of a television image based on an overlay display at an arbitrary position on a PC monitor during PC work, shifting a work area to an arbitrary position and changing the size of the area to an arbitrary size even when operability becomes worse due to overlap of the work area and a television overlay area, and significantly improving the operability.

### Means for Solving the Problem

In order to accomplish the object, according to the present invention, there is provided an image processing device including: a first external image input means for inputting an image signal from an external computer; a second external image input means for inputting an image signal from external video equipment; a tuner means for receiving an external video signal; at least one image output means; a means for selecting a first image signal from the first external image input means, or a second image signal from one of the second external image input means and the tuner means, or an overlay image signal in which the first image signal and the second image signal are overlaid as one image, and screen-displaying and outputting the selected image signal from the image output means; and an interface means for receiving a plurality of commands from the external computer or transmitting and receiving data with the external computer, wherein in response to a command of the external computer received through the interface means, an image based on the first image signal, the second image signal, or the overlay image signal is screen-displayed on the image output means, and output or non-output of an icon display is selectively controlled to an arbitrary position in which no icon display is present on a display screen of the image in the image output means.

In the image processing device of the invention, a means is provided to record the first image signal, the second image signal, or an image signal from the tuner as image data, and a means is provided to generate an image signal for reproducing the image data and screen-displaying and outputting the reproduced image data from the image output means.

In the image processing device of the invention, a means is provided to perform a process for arbitrarily changing at least one of a display position and a display size on a display screen of an image based on the overlay image signal in response to a command from the external computer.

In the image processing device of the invention, a means is provided to perform a process for selecting the first image signal, the second image signal, or the overlay image signal and screen-displaying and outputting the selected image signal from the image output means in response to a command from the external computer.

### ADVANTAGE OF THE INVENTION

According to the invention as described above, a television screen or a PC screen can be displayed on the monitor of an existing PC or an overlay display of the combined two screens can be carried out. The displays can be easily changed to any position with any window size by an operation through the PC. Even if the PC is stopped, a television screen can be displayed and viewed on the monitor of the PC. The invention can be used for a recorder.

Accordingly, a television or recorded program can be viewed without increasing a PC load, and a reduced screen of a television image based on an overlay display can be displayed at an arbitrary position on a PC monitor during PC work.

A work area can be shifted to an arbitrary position and a change to an arbitrary size can be made even when operability becomes worse due to overlap of the work area and a television overlay area, thereby significantly improving the operability.

When a mail or the like is received on the PC while a television screen is viewed on the PC monitor, the information notifying the reception of a mail or the like can be immediately displayed on the screen and a reception status and content of mail can be immediately confirmed.

### BRIEF DESCRIPTION OF THE DRAWINGS

FIG. 1 is a block diagram showing a configuration of an image processing device of an embodiment 1 of the invention.

FIG. 2 is a view illustrating a configuration of a system using the image processing device of the embodiment 1.

FIG. 3 is a view illustrating a monitor output in the image processing device of the embodiment 1.

FIG. 4 is a flowchart (1) of an operation for issuing a command from a PC side to the image processing device of the embodiment 1.

FIG. 5 is a flowchart (2) of an operation for issuing a command from the PC side to the image processing device of the embodiment 1.

FIG. 6 is a partial flowchart (1) showing an operation of the image processing device of the embodiment 1.

FIG. 7 is a partial flowchart (2) showing an operation of the image processing device of the embodiment 1.

FIG. 8 is a block diagram showing a configuration of an image processing device of an embodiment 2 of the invention.

FIG. 9 is a view illustrating a configuration of a system using the image processing device of the embodiment 2.

FIG. 10 is a view illustrating a monitor output (1) in the image processing device of the embodiment 2.

FIG. 11 is a view illustrating a monitor output (2) in the image processing device of the embodiment 2.

FIG. 12 is a block diagram showing a configuration of an image processing device of an embodiment 3 of the invention.

FIG. 13 is a view illustrating a monitor output in the image processing device of the embodiment 3.

### PREFERRED EMBODIMENTS FOR CARRYING OUT THE INVENTION

Hereinafter, image processing devices showing embodiments of the invention will be described in detail with reference to the accompanying drawings.

### Embodiment 1

An image processing device of an embodiment 1 of the invention will be described.

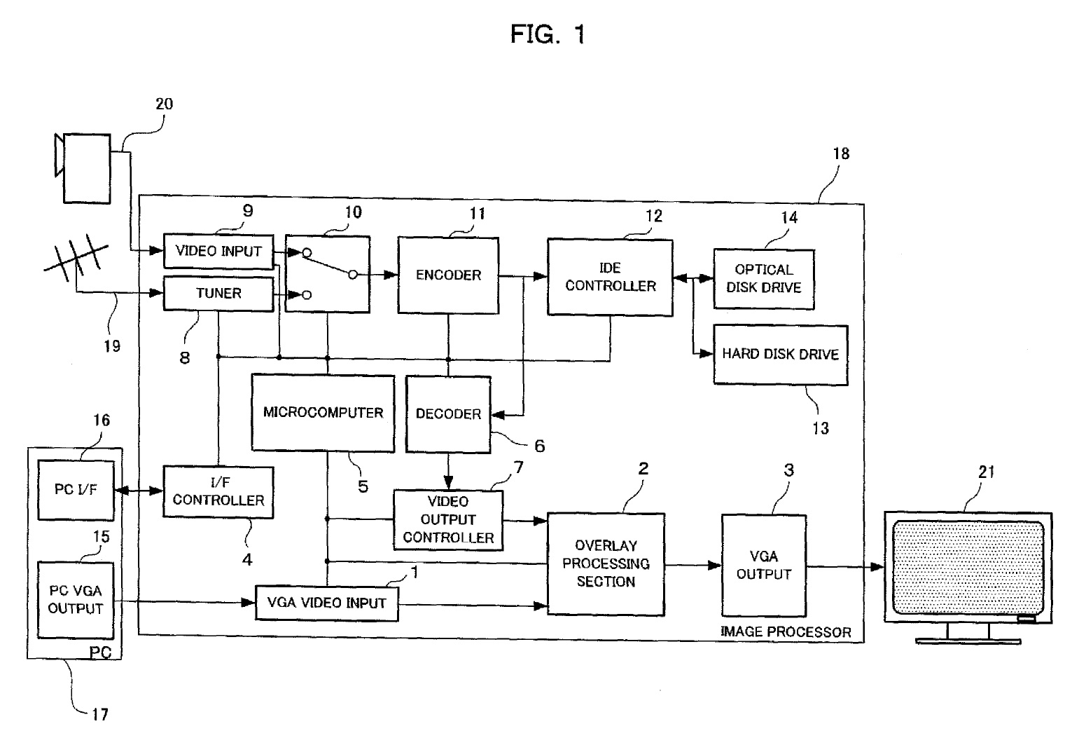

FIG. 1 is a block diagram showing a configuration of the image processing device of the embodiment 1 of the invention. In FIG. 1, a video graphics array (VGA) video input unit (or first external input means) 1 of an image processing device 18 first inputs an image signal output from a PC VGA output unit 15 of a PC (or external computer) 17. Through an interface (hereinafter, referred to as I/F) controller (or interface means) 4, a microcomputer 5 transmits and receives commands and data with the PC 17 via a PC I/F 16. In response to the commands, the microcomputer 5 detects the presence of a signal to the VGA video input unit 1 and a tuner 8 or a video input unit (or second external input means) 9 while switching a selector 10, controlling an encoder 11, designating an image data output destination, controlling a decoder 6, controlling a video output controller 7, controlling an overlay processing section 2, and controlling an integrated drive electronics (IDE) controller 12.

The tuner 8 outputs a channel-selected television image signal to the selector 10 in response to a channel selection command input from the microcomputer 5. The video input unit 9 outputs, to the selector 10, an image signal input from an external video input signal 20 of, for example, a video camera or the like serving as external video equipment. In response to the command from the microcomputer 5, the selector 10 selects the image signal from the tuner 8 or the video input unit 9 and outputs the image signal to the encoder 11. In response to the command from the microcomputer 5, the encoder 11 converts the image signal from the selector 10 into image data and outputs the image data to the decoder 6 or the IDE controller 12.

In response to the command from the microcomputer 5, the IDE controller 12 records the image data from the encoder 11 to a hard disk drive 13 or an optical disk drive 14. The IDE controller 12 reads out the recorded image data from the hard disk drive 13 or the optical disk drive 14 and outputs the recorded image data to the decoder 6.

In response to the command from the microcomputer 5, the decoder 6 selects image data input from the encoder 11 or the IDE controller 12, converts the image data into an image signal, and outputs the image signal to the video output controller 7. The video output controller 7 processes the image signal from the decoder 6 in a National Television Standards Committee (NTSC) format and outputs the processed image signal to the overlay processing section 2. The overlay processing section 2 receives the image signal from the VGA video input unit 1 and the image signal from the video output controller 7 and outputs, to a VGA output unit 3, either one image signal or the other or an overlay image signal in which the two image signals are overlaid in response to a control command instructed from the microcomputer 5.

The VGA output unit 3 outputs the image signal to a monitor (or image output means) 21. In response to the command from the PC 17, the overlay processing section 2 controls a display or non-display at an arbitrary position of an icon in which an operation and function of a mouse or the like are indicated and a display is varied in accordance with manipulation of the mouse or the like.

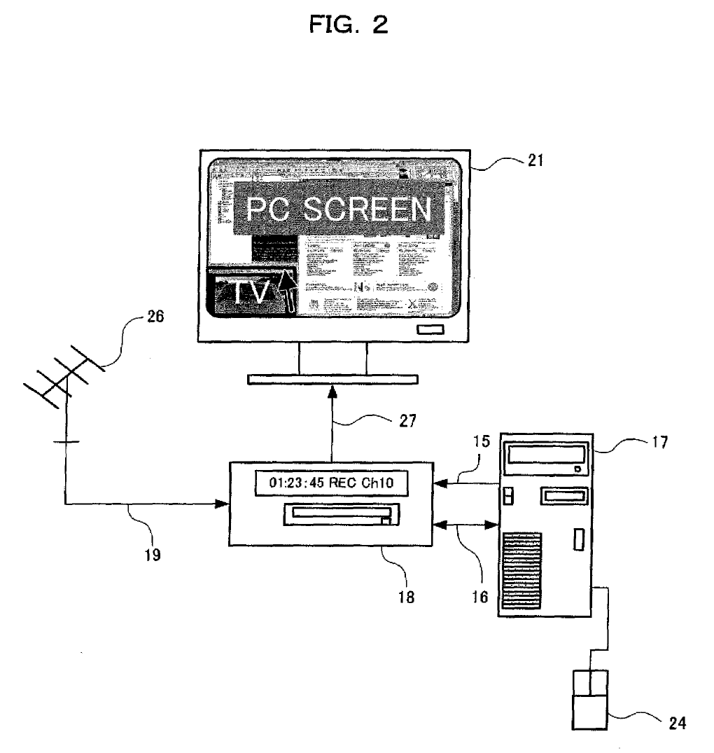

FIG. 2 is a view illustrating a configuration of a system using the image processing device of the embodiment 1. In FIG. 2, a television radio wave serving as an antenna input signal 19 from a TV reception antenna 26 is input to the image processing device 18. A video input signal from a PC VGA output unit 15 of a PC 17 as a VGA signal from the PC 17 is input to the image processing device 18. In response to manipulation of a mouse 24, the PC 17 issues an instruction to the image processing device 18 serving as a command from the PC 17 via a PC I/F 16 (for example, an I/F for a universal serial bus (USB) connection). A monitor 21 displays and outputs a video output signal 27 serving as a VGA output from the image processing device 18.

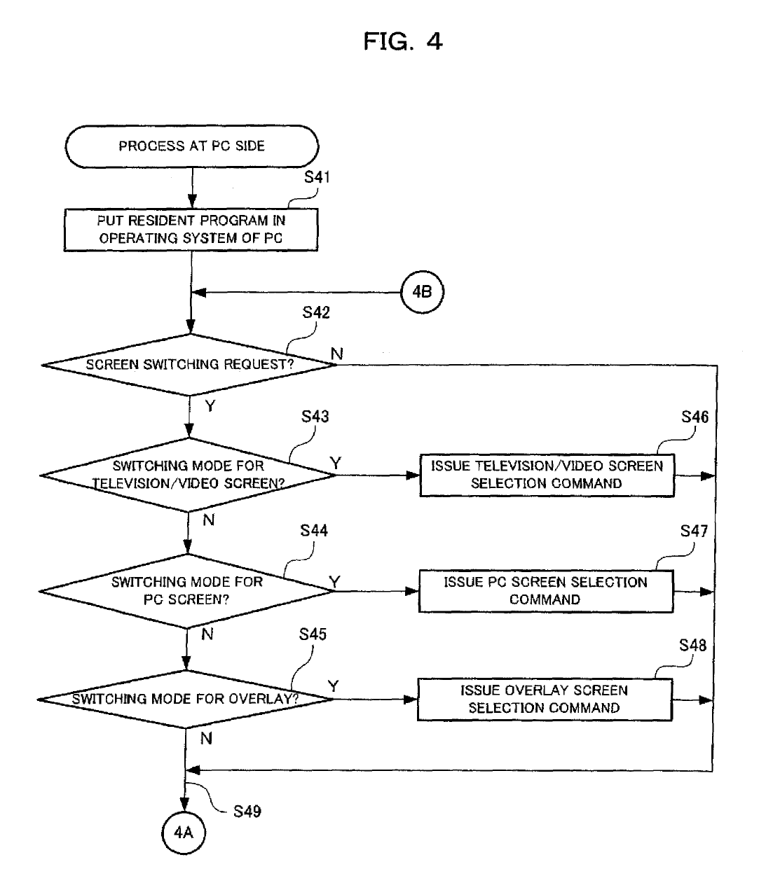

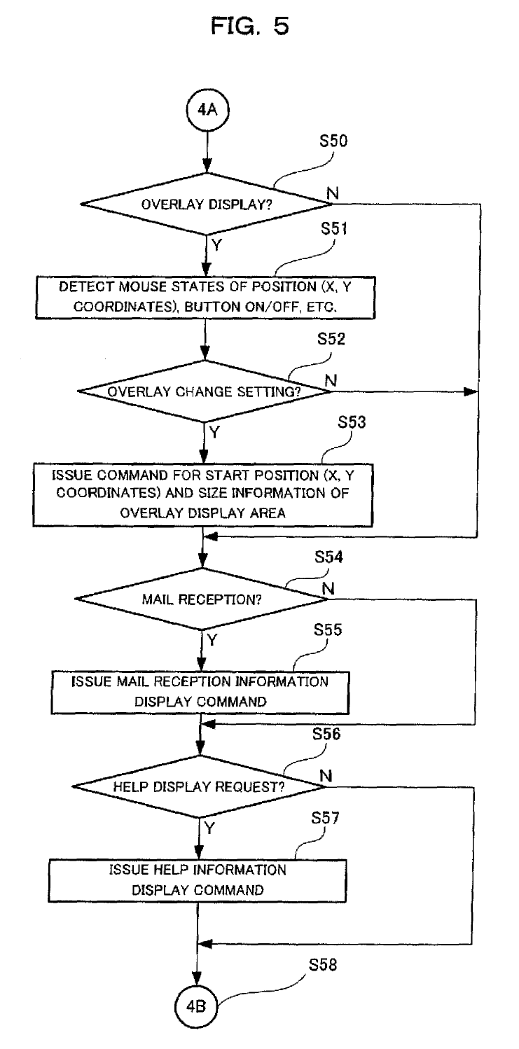

FIG. 4 is a flowchart (1) of an operation for issuing a command from the PC side to the image processing device of the embodiment 1. FIG. 5 is a flowchart (2) of an operation for issuing a command from the PC side to the image processing device of the embodiment 1.

In order to run software for controlling the image processing device of the embodiment 1 in the PC 17, a program is resident in an operating system on the PC in S41. Next, in S42, it is monitored whether there is a screen switching request in a mouse or keyboard operation. When there is no switching request, the flow branches to 4A of S49. When there is the switching request, the flow proceeds to S43.

In S43, it is determined whether a switching mode is a television or video screen. In the case of the television or video screen, a television/video screen selection command is issued to the image processing device 18 in S46 and then the flow branches to 4A of S49. Otherwise, it is determined whether the switching mode is a PC screen in S44. When the PC screen is selected, a PC screen selection command is issued to the image processing device 18 in S47 and then the flow branches to 4A of S49. Otherwise, it is determined whether the switching mode is an overlay screen in S45. When the overlay screen is selected, an overlay screen selection command is issued to the image processing device 18 in S48 and then the flow branches to 4A of S49. Otherwise, the flow directly branches to 4A of S49.

Then, it is determined whether a display screen is currently being overlay-displayed in S50. If not, the flow branches to S54. If the display screen is currently being overlay-displayed, the flow branches to S51 to detect a mouse state. At this time, a button state or a position in the PC screen related to the mouse is detected. Next, the flow proceeds to S52 to determine whether an overlay change is set. When there is no change, the flow branches to S54. When the change is made, a command for information regarding a start position and size of an overlay display area is issued to the image processing device 18 in S53.

Next, it is determined whether there is a mail reception in S54. When there is no mail reception, the flow branches to S56. When there is the mail reception, a mail reception information display command is issued to the image processing device 18 in S55. Next, it is determined whether there is a help display request in S56. When there is no request, the flow branches to 4B of S58. When there is the help information display request, a help information display command is issued to the image processing device 18 in S57 and then the flow branches to 4B of S58. Then, a transition is taken from 4B of S58 to S42.

Moreover, another application executes a recording and playback, edit or reservation command to the image processing device in this embodiment.

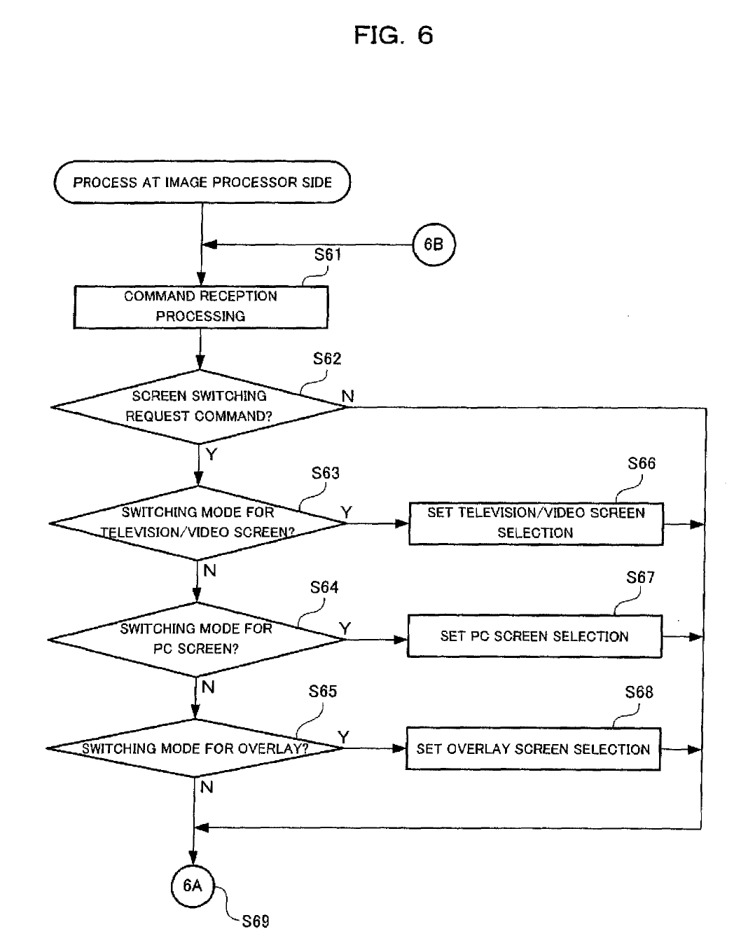

FIG. 6 is a partial flowchart (1) showing an operation of the image processing device of this embodiment 1.

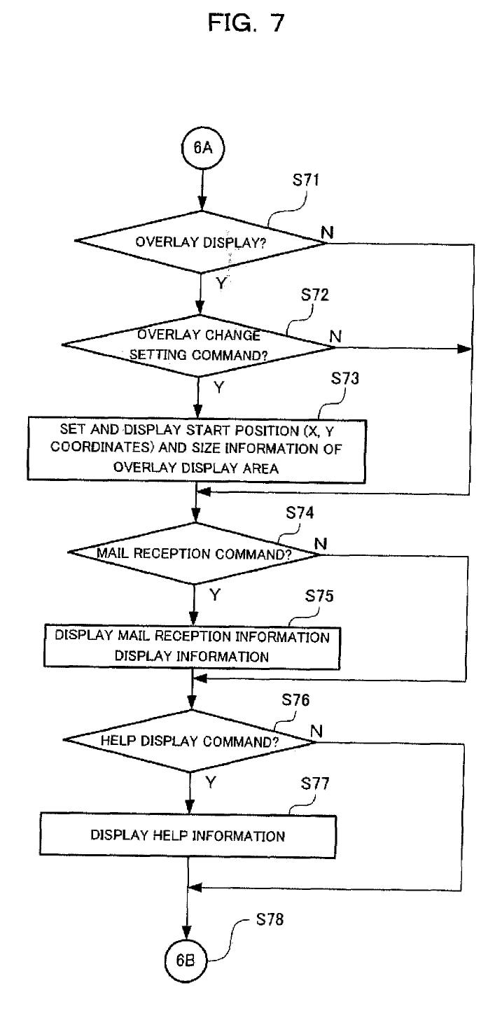

FIG. 7 is a partial flowchart (2) showing an operation of the image processing device of this embodiment 1.

In order to control the image processing device of this embodiment 1, a command received from the PC 17 is processed in S61. Next, it is determined whether there is a screen switching request command from the PC 17 in S62. When there is no switching request command, the flow branches to 6A of S69. When there is the switching request command, the flow proceeds to S63. In S631 it is determined whether a switching mode is a television or video screen. In the case of the television or video screen, a television/video screen selection is set in S66 and then the flow branches to 6A of S69. Otherwise, it is determined whether the switching mode is a PC screen in S64. When the PC screen is selected, a PC screen selection is set in S67 and then the flow branches to 6A of S69. Otherwise, it is determined whether there is an overlay screen command in S65. When an overlay screen is selected, an overlay screen selection is set in S68 and then the flow branches to 6A of S69. Otherwise, the flow directly branches to 6A of S69.

Moreover, it is determined whether a display screen is currently being overlay-displayed in S71. If not, the flow branches to S74. If the display screen is currently being overlay-displayed, the flow branches to S72 to determine whether there is a command for setting an overlay change. When there is no command, the flow branches to S74. When the change is made, information regarding a start position and size of an overlay display area is set and displayed in S73. Next, it is determined whether there is a mail reception command in S74. When there is no mail reception command, the flow branches to S76. When there is the mail reception command, an icon or message is displayed and output on an image screen by setting a mail reception information display in S75. Next, it is determined whether there is a help display command in S76. When there is no command, the flow branches to GB of S78. When there is the help information display command, a manipulation method is displayed and output on an image screen by setting a help information display in S77 and then the flow branches to 6B of S78. Then, a transition is taken from 6B of S78 to S61.

In the image processing device of this embodiment 1, an image of the image signal of the VGA video input unit 1 or the image signal of the tuner 8 or the video input unit 9 or the overlay display image signal can be selected and output to the monitor 21.

The image signal of the tuner 8 or the video input unit 9 can be recorded as image data by the encoder 11 in the hard disk drive 13 or the optical disk drive 14 via the IDE controller 12. The image data is read out and converted into an image signal by the decoder 6, such that the image data can be output to the monitor 21 according to selection or overlay display.

A command from the PC can be input to the microcomputer 5 via the I/F controller 4 by connecting the PC 17 to the I/F controller 4. The microcomputer 5 can change an image to be output to the VGA output unit 3 in real time in response to the command from the PC 17 by controlling the overlay processing section 2. Thus, a screen position and a screen size of an overlay display can be arbitrarily changed according to manipulation of the PC 17. Moreover, an output image signal can be switched to a VGA input signal, a television image signal, or an overlay image signal of the VGA input signal and the television image signal according to manipulation of the PC 17, such that the image signal can be output to the monitor 21.

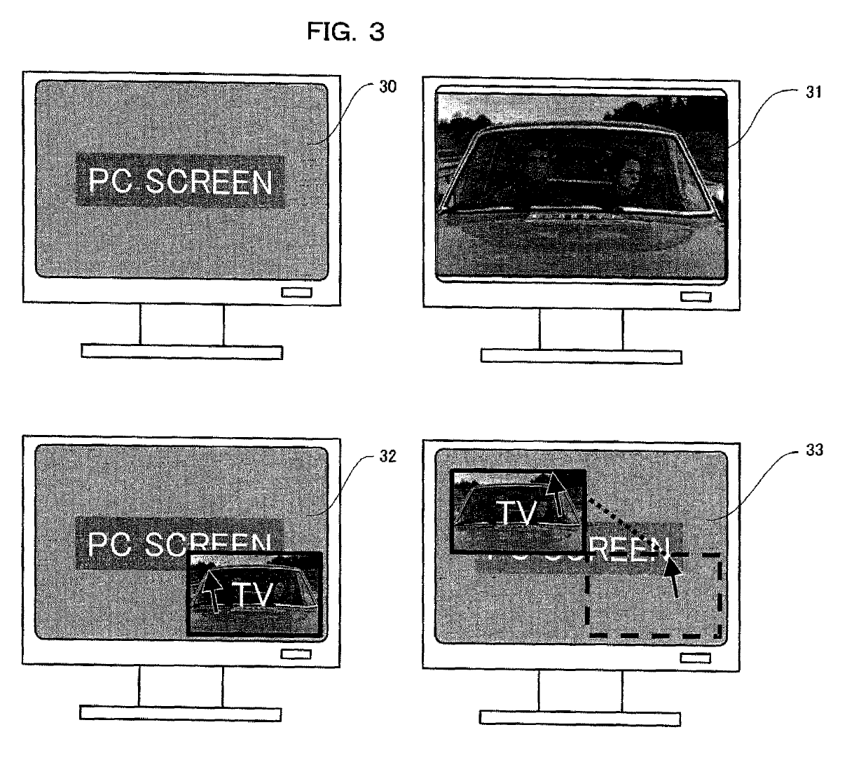

FIG. 3 is a view illustrating a monitor output in the image processing device of this embodiment 1, and shows an example of a VGA input image (or PC screen) 30, a television image (or TV screen) 31, or an overlay image 32 of the VGA input image (or PC screen) 30 and the television image (or TV screen) 31 on the monitor. Reference numeral 33 denotes an image in the case where a television image portion of the overlay image 32 is shifted to the upper left of the monitor screen by the mouse or the like.

As the command from the PC 17 is issued via the I/F controller 4, the microcomputer 5 can control the IDE controller 12 and can read out image data stored in the hard disk drive 13 or the optical disk drive 14, make a recording reservation, or edit or delete data.

Since an image signal processing is possible in an operation of the image processing device in this embodiment 1 as described above, television watching or video input or recorded program reception is possible while at work on one PC monitor and the PC without adding a load of the PC side. Also, a television image can be displayed on a reduced screen by the overlay display at an arbitrary position on the monitor.

A size and positional relation of the television image and the VGA input image of the overlay image 32 can be arbitrarily designated, and also all the two image signals can be displayed by dividing the display into a plurality of displays on the monitor. According to this manipulation, the overlay-displayed screen can be shifted and invisible information hidden by the overlay-displayed screen can be easily confirmed.

### Embodiment 2

An image processing device of an embodiment 2 of the invention will be described.

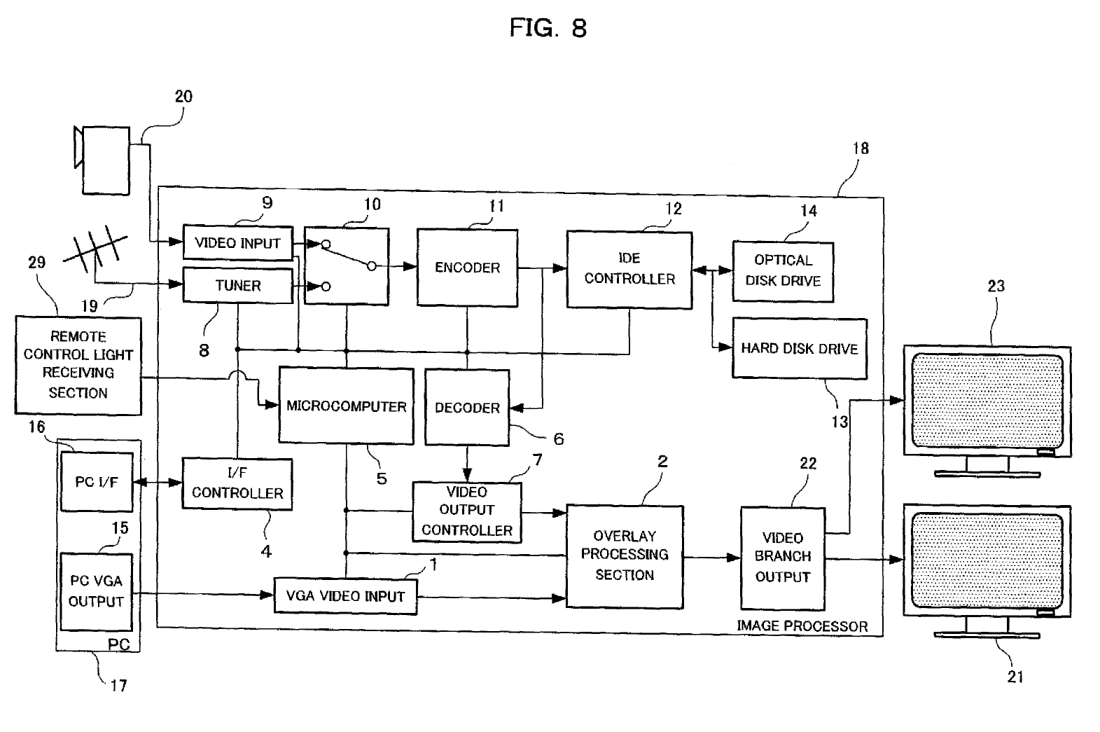

FIG. 8 is a block diagram showing a configuration of the image processing device of the embodiment 2 of the invention. In FIG. 8, a VGA video input unit 1 of an image processing device 18 first inputs an image signal output from a PC VGA output unit 15. Through an I/F controller 4, a microcomputer 5 transmits and receives commands and data with a PC 17 via a PC I/F 16. In response to the commands, the microcomputer 5 detects the presence of a signal to the VGA video input unit 1 and a tuner 8 or a video input unit 9 while switching a selector 10, controlling an encoder 11, designating an image data output destination, controlling a decoder 6, controlling a video output controller 7, controlling an overlay processing section 2, and controlling an IDE controller 12.

The tuner 8 outputs a channel-selected television image signal to the selector 10 in response to a channel selection command input from the microcomputer 5. The video input unit 9 outputs an image signal input from an external video input signal 20 to the selector 10. In response to the command from the microcomputer 5, the selector 10 selects the image signal from the tuner 8 or the video input unit 9 and outputs the image signal to the encoder 11. In response to the command from the microcomputer 5, the encoder 11 converts the image signal from the selector 10 into image data and outputs the image data to the decoder 6 or the IDE controller 12.

In response to the command from the microcomputer 5, the IDE controller 12 records the image data from the encoder 11 to a hard disk drive 13 or an optical disk drive 14. The IDE controller 12 reads out the recorded image data from the hard disk drive 13 or the optical disk drive 14 and outputs the recorded image data to the decoder 6. In response to the command from the microcomputer 5, the decoder 6 selects image data input from the encoder 11 or the IDE controller 12, converts the image data into an image signal, and outputs the image signal to the video output controller 7.

The video output controller 7 processes the image signal from the decoder 6 in an NTSC format and outputs the processed image signal to the overlay processing section 2. The overlay processing section 2 receives the image signal from the VGA video input unit 1 and the image signal from the video output controller 7 and outputs, to a video branch output unit 22, either one image signal or the other or an overlay image signal in which the two image signals are overlaid in response to a control command instructed from the microcomputer 5. The video branch output unit 22 outputs the image signal to a monitor 21 and a monitor (2) 23.

Moreover, a remote control light receiving section 29 receives manipulation information from an external remote control and then transmits a manipulation command of image selection or playback, recording, fast forward, rewind, pause, or the like to the microcomputer 5. The PC I/F 16 uses a conventional wired I/F means for a connection with another external PC. Alternatively, the manipulation may be possible from a distance by mounting a wireless I/F means. From a remote place, the manipulation may be possible using a LAN connection serving as the above-described I/F means.

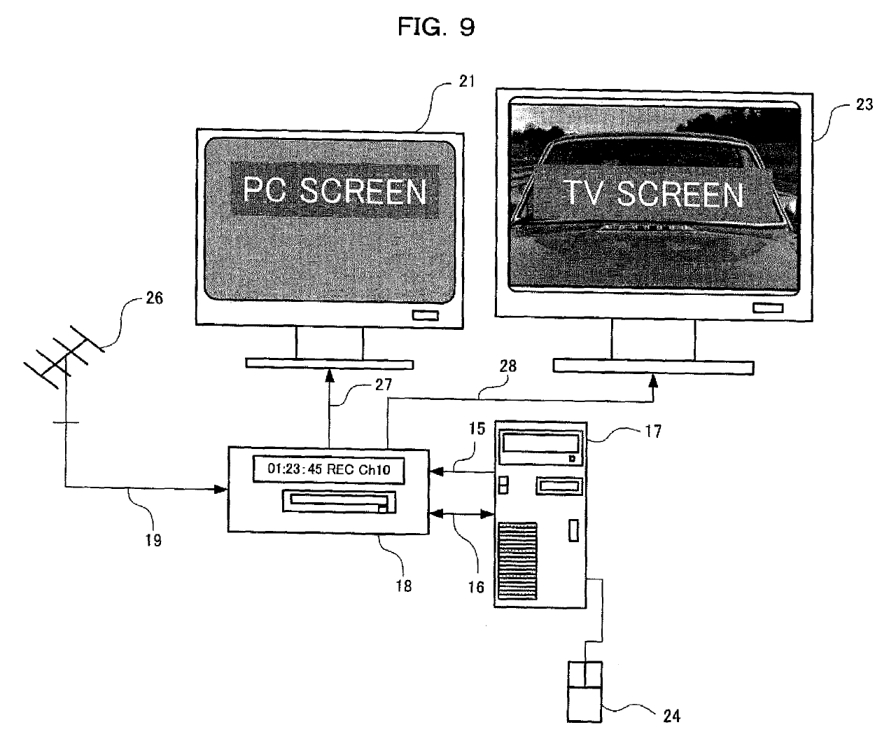

FIG. 9 is a view illustrating a configuration of a system using the image processing device of the embodiment 2. In FIG. 9, a television radio wave serving as an antenna input signal 19 from a TV reception antenna 26 is input to the image processing device 18. A video input signal from a PC VGA output unit 15 of the PC 17 serving as a VGA signal from the PC 17 is input to the image processing device 18. In response to manipulation of a mouse 24, the PC 17 issues an instruction to the image processing device 18 as a command from the PC 17 via the PC I/F 16 (for example, an I/F for a USB connection). A PC screen of a video output signal 27 output from the image processing device 18 is output to the monitor 21 and a television screen of a video output signal 28 is output to the monitor (2) 23.

In the image processing device of this embodiment 2, an image of the image signal of the VGA video input unit 1 and the image signal of the tuner 8 or the video input unit 9 or the overlay display image signal can be selected from the video branch output unit 22 and output to the monitor 21 or the monitor 23.

The image signal of the tuner 8 or the video input unit 9 can be recorded as image data by the encoder 11 in the hard disk drive 13 or the optical disk drive 14 via the IDE controller 12. The image data is read out and converted into an image signal by the decoder 6, such that the image data can be arbitrarily selected and output to the monitor 21 or the monitor 23 by selecting or overlay-displaying the image signals.

A command from the PC can be input to the microcomputer 5 via the I/F controller 4 by connecting the PC 17 to the I/F controller 4. The microcomputer 5 can change an image to be output to the video branch output unit 22 in real time by controlling the overlay processing section 2 in response to the command.

Thus, a screen position and a screen size of an overlay display can be arbitrarily changed according to manipulation of the PC 17. Moreover, an output image signal can be switched to a VGA input signal, a television image signal, or an overlay image signal of the VGA input signal and the television image signal according to manipulation of the PC 17, such that a monitor output is carried out. Alternatively, each image can be output to the monitor 21 or the monitor (2) 23.

As the command from the PC 17 is issued via the I/F controller 4, the microcomputer 5 can control the IDE controller 12 and can read out image data stored in the hard disk drive 13 or the optical disk drive 14, make a recording reservation, or edit or delete data.

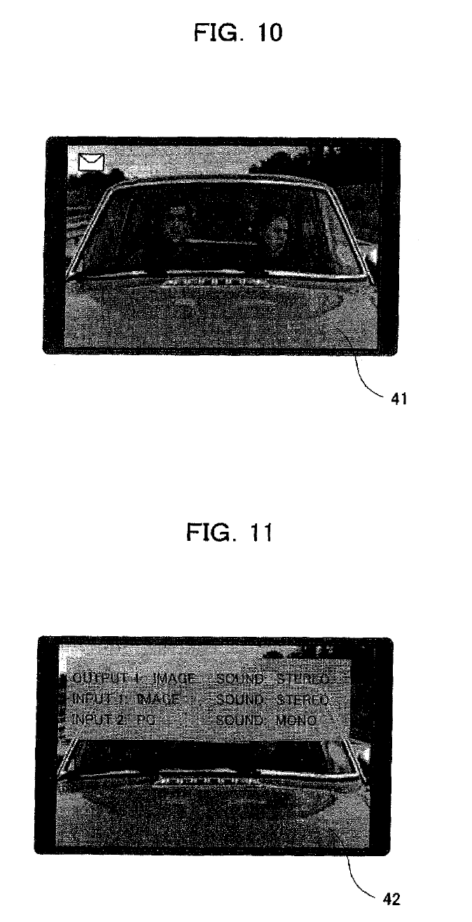

When a scheduling management software or time management event, a mail reception, or the like operating on the PC 17 is generated, a command is issued from the PC 17 to the image processing device 18. The microcomputer 5 interprets the event, and displays a graphic form to a VGA input signal, a television image signal, or an overlay image signal of the VGA input signal and the television image signal, such that the event occurred in the PC 17 can be detected while the image is viewed. For example, when a mail reception occurs on the PC 17 while a program is viewed through the TV screen 31 of FIG. 3 at normal times, a command is issued to the image processing device 18. As shown in a TV screen 41 of FIG. 10, for example, an icon can be displayed in a graphic form for indicating when a mail reception event occurs.

The microcomputer 5 can display a state of a device connected to the image processing device 18 on the monitor 21 or the monitor (2) 23 through the overlay processing section 2 by issuing a command for displaying a connection state of the image processing device 18 from the PC 17. For example, connection statuses of external devices can be confirmed by issuing a command for checking a connection status from the PC 17 in the TV screen 31 of FIG. 3 and displaying a connection state of the image processing device 18 as shown in a TV screen 42 of FIG. 11.

Since image signal processing is possible in an operation of the image processing device in this embodiment 2 as described above, television watching or video input or recorded program reception is possible while at work on the PC monitor, the television monitor, and the PC without adding a load of the PC side. Also, a television image can be displayed on a reduced screen by the overlay display at an arbitrary position on the monitor.

A size and positional relation of the television image and the VGA input image of the overlay image 32 can be arbitrarily designated, and also all the two image signals can be displayed by dividing the display into a plurality of displays on the monitor. According to this manipulation, the overlay-displayed screen can be shifted and invisible information hidden by the overlay-displayed screen can be easily confirmed.

### Embodiment 3

An image processing device of an embodiment 3 of the invention will be described.

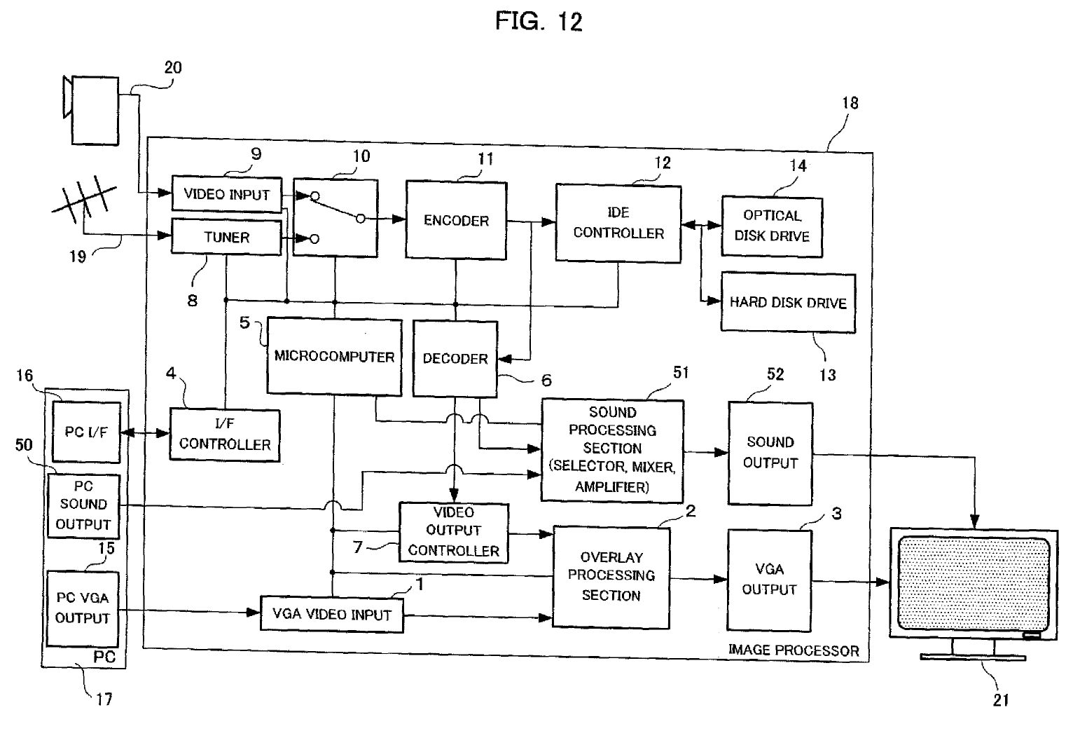

FIG. 12 is a block diagram showing a configuration of the image processing device of this embodiment 3. In FIG. 12, a VGA video input unit (or first external image input means) 1 of an image processing device 18 first inputs an image signal output from a PC VGA output unit 15 of a PC (or external computer) 17. Through an interface (hereinafter, referred to as I/F) controller (or interface means) 4, a microcomputer 5 transmits and receives commands and data with the PC 17 via a PC I/F 16. In response to the commands, the microcomputer 5 detects the presence of a signal to the VGA video input unit 1 and a tuner 8 or a video input unit (or second external image input means) 9 while switching a selector 10, controlling an encoder 11, designating an image data output destination, controlling a decoder 6, controlling a video output controller 7, controlling an overlay processing section 2, and controlling an IDE controller 12.

The tuner 8 outputs a channel-selected television image signal to the selector 10 in response to a channel selection command input from the microcomputer S. The video input unit 9 outputs, to the selector 10, an image signal input from an external video input signal 20 of, for example, a video camera or the like serving as external video equipment. In response to the command from the microcomputer 5, the selector 10 selects the image signal from the tuner 8 or the video input unit 9 and outputs the image signal to the encoder 11. In response to the command from the microcomputer 5, the encoder 11 converts the image signal from the selector 10 into image data and outputs the image data to the decoder 6 or the IDE controller 12.

In response to the command from the microcomputer 5, the IDE controller 12 records the image data from the encoder 11 to a hard disk drive 13 or an optical disk drive 14. The IDE controller 12 reads out the recorded image data from the hard disk drive 13 or the optical disk drive 14 and outputs the recorded image data to the decoder 6.

In response to the command from the microcomputer 5, the decoder 6 selects image data input from the encoder 11 or the IDE controller 12, converts the image data into an image signal, and outputs the image signal to the video output controller 7. The video output controller 7 processes the image signal from the decoder 6 in an NTSC format and outputs the processed image signal to the overlay processing section 2. The overlay processing section 2 receives the image signal from the VGA video input unit 1 and the image signal from the video output controller 7 and outputs, to a VGA output unit 3, either one image signal or the other or an overlay image signal in which the two image signals are overlaid in response to a control command instructed from the microcomputer 5.

The VGA output unit 3 outputs the image signal to a monitor (or image output means) 21. In response to the command from the PC 17, the overlay processing section 2 controls a display or non-display at an arbitrary position of an icon in which an operation and function of a mouse or the like are indicated and a display is varied in accordance with manipulation of the mouse or the like.

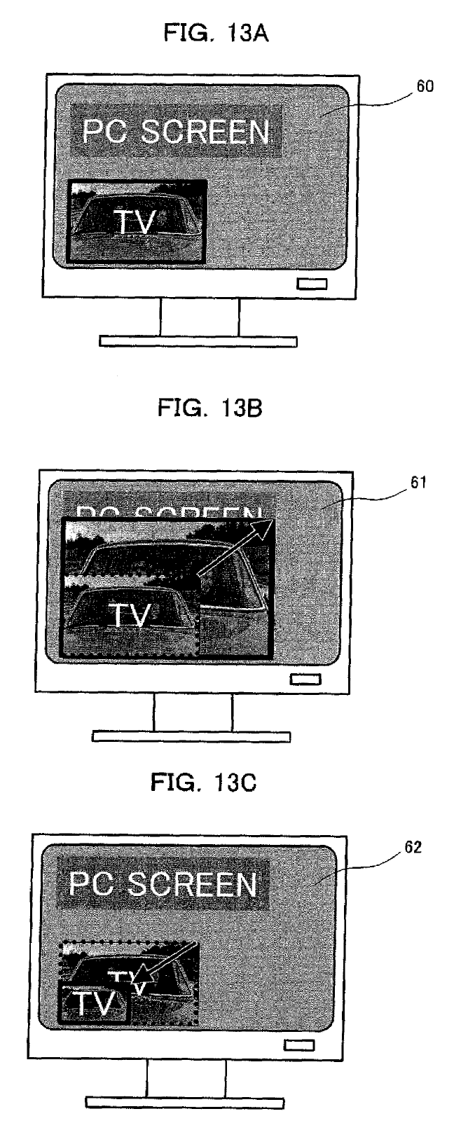

A sound processing section (or selector, mixer, or amplifier) 51 receives a sound signal output from a PC sound output unit 50 of the PC 17 and a sound signal synchronized with an image signal from the decoder 6. Moreover, the sound processing section 51 outputs, to a sound output unit 52, a sound signal synchronized with an image signal output to the VGA output unit 3 or a mixed and selected sound signal. The sound output unit 52 outputs the sound signal to the monitor 21 in a specified output. When an overlay image output is selected (in an original overlay display screen 60 of FIG. 13(a)), a level of the sound signal can increase (corresponding to an enlarged overlay display screen 61 of FIG. 13(b)) or decrease (corresponding to a reduced overlay display screen 62 of FIG. 13(c)), in synchronization with an area in which an overlay image is displayed.

### INDUSTRIAL APPLICABILITY

An image processing device of the invention is capable of selecting a plurality of input images as one or more images or overlaying and displaying the input images at an arbitrary position, and recording or reproducing the input images. Therefore, the invention is useful for an image processing device connected to a television or PC monitor.

1. An image processing device comprising:
a first external image input means for inputting an image signal from an external computer;
a second external image input means for inputting an image signal from external video equipment;
a tuner means for receiving an external television signal;
at least one image output means;
a means for selecting a first image signal from the first external image input means, a second image signal from the second external image input means or the tuner means, or an overlay image signal in which the first image signal and the second image signal are overlaid as one image, and screen-displaying and outputting the selected image signal from the image output means; and
an interface means for receiving a plurality of commands from the external computer or transmitting and receiving data with the external computer,
wherein in response to a command of the external computer received through the interface means, an image based on the first image signal, the second image signal, or the overlay image signal is screen-displayed on the image output means, and output or non-output of an icon display is selectively controlled to an arbitrary position in which no icon display is present on a display screen of the image in the image output means.

2. The image processing device of claim 1, wherein a means is provided to record the first image signal, the second image signal, or an image signal from the tuner as image data, and a means is provided to generate an image signal for reproducing the image data and screen-displaying and outputting the reproduced image data from the image output means.

3. The image processing device of claim 1, wherein a means is provided to perform processing for arbitrarily changing at least one of a display position and a display size on a display screen of an image based on the overlay image signal in response to a command from the external computer.

4. The image processing device of claim 1, wherein a means is provided to perform processing for selecting the first image signal, the second image signal, or the overlay image signal and screen-displaying and outputting the selected image signal from the image output means in response to a command from the external computer.

5. The image processing device of claim 4, wherein a means is provided to perform processing for performing recording, playback and recording reservation operations on the first image signal or the second image signal and editing and deleting recorded data in response to a command from the external computer.

6. The image processing device of claim 4, wherein a mean is provided to perform processing for receiving display data of an equivalent icon to display the equivalent icon, when the icon indicating the position is hidden in a screen display portion of the image based on the overlay image signal, or perform processing for displaying another icon in place of the icon indicating the position, in response to a command from the external computer.

7. The image processing device of claim 1, wherein a means is provided to detect that no image signal is supplied from the external computer according to a power OFF or standby operation of the external computer while an image signal is input from the external computer, a means is provided to stop an image signal from being supplied to the image output means when detecting that no image signal is supplied from the external computer, and a means is provided to validate or invalidate an operation for stopping the image signal from being supplied.

8. The image processing device of claim 1, wherein when the image output means includes a plurality of image output means, a means is provided to select the image based on the first image signal, the second image signal, or the overlay image signal from each of the plurality of image output means and screen-display and output the selected image in response to a command from the external computer.

9. The image processing device of claim 5, wherein a wired or wireless remote manipulation means is provided.

10. The image processing device of claim 1, wherein in response to a command issued according to an event of the external computer, output or non-output of a display by the icon or a display by a character of information regarding the event is selectively controlled in an image to be screen-displayed and output to the image output means.

11. The image processing device of claim 1, wherein output or non-output of a display by the icon or a display by a character of connection information of external equipment and information regarding usage is selectively controlled in an image to be screen-displayed and output to the image output means in response to a command from the external computer or manipulation from the remote manipulation means in a state in which a connection to the external computer is established via the interface means.

12. The image processing device of claim 1, wherein a first sound input means and a second sound input means are provided to input sounds respectively synchronized with the first image signal and the second image signal, and a sound output means is provided to output a first sound from the first sound input means when the first image signal is selected, output a second sound from the second sound input means or the tuner when the second image signal is selected, and output a combined sound of the first sound and the second sound when the overlay image signal is selected.

13. The image processing device of claim 12, wherein a means is provided to adjust a size of a child screen of an image based on the first image signal or the second image signal according to a display size of an image based on the overlay image signal when the image based on the overlay image signal is displayed, adjust a size of a corresponding sound signal synchronized with the size of the child screen displayed, and output the sound signal to the sound output means.
